(19) United States
(12) Patent Application Publication
(10) Pub. No.: US 2012/0237387 A1
(43) Pub. Date: Sep. 20, 2012

(54) STAINLESS STEEL HAVING LOCAL VARIATIONS IN MECHANICAL RESISTANCE

(75) Inventors: Pierre-Olivier Santacreu, Isbergues (FR); Aurelien Pic, Paris (FR); Fabrice Pinard, Paris (FR)

(73) Assignee: APERAM, Luxembourg (LU)

(21) Appl. No.: 13/497,155

(22) PCT Filed: Sep. 21, 2009
(86) PCT No.: PCT/FR09/01110

§ 371 Date: Jun. 5, 2012

(51) Int. Cl. C22C 38/18; B23K 15/00; B23K 26/00; H05B 6/10

(52) U.S. Cl. 420/34; 219/646; 219/121.35; 219/121.85

(57) ABSTRACT

The disclosure mainly relates to a stainless steel sheet containing a minimum of 10.5% by weight of Cr and a maximum of 1.2% by weight of C, the microstructure of which is martensitic or austeno-martensitic and comprises at least 2% by volume of martensite, essentially characterized in that it comprises at least one local portion of lesser mechanical resistance, having a martensitic content at least 10% lower than that of the remainder of said sheet; said local portion being at least partly with a thickness equal to that of said sheet. The disclosure also relates to a method for manufacturing this steel sheet and to a steel part which may be obtained by deformation of this sheet.

### FIELD OF THE DISCLOSURE

The present invention relates to the shaping of stainless steel sheets and more particularly to those having high mechanical resistances.

### BACKGROUND

Stainless steel sheets are widely used in the automotive, construction and industry sectors in general, because of their excellent corrosion resistance. Within the scope of these applications, these sheets are more generally shaped so as to be, for example, used in the form of profiles, square tubes, bumper beams, shafts, doorframes. These shaping operations are most often achieved by bending, profiling and die-stamping.

The use, within the scope of these applications of stainless steel grades having high mechanical resistance, greater than 780 MPa, is made very difficult by an elongation at break which rapidly decreases with the increase in the break resistance. This phenomenon is the source of many drawbacks:
the minimum binding radii are generally greater than twice the thickness of the sheet (and up to six times) with at best a bending angle which does not exceed 120°, not allowing the manufacturing of tubes with small curvature radii.
springback is very marked and makes optional welding of the profiles difficult
limited residual elongation in the deformed areas is the source of brittle failures during dynamic stress, typically at a deformation rate comprised between 1 and 1,000s-⁻¹ like in a crash.

A solution consists of locally treating the area to be shaped so as to facilitate deformation. U.S. Pat. No. 5,735,163 thereby describes a method for shaping blanks in which a local portion of the blank is hardened before shaping. This hardening is generated by providing strong density energy. The rise in temperature which results therefrom causes transformation of the local microstructure into martensite or into bainite, which locally increases mechanical resistance. In the case of stamping, by forming hardened lines parallel to the direction of the deformation it is possible to avoid the failure of not very die stampable grades. In the case of bending, the structural transformation related to the formation of martensite or bainite on the outer side of the blank to be bent generates a local compressive stress. During the bending, this stress partly cancels out the extension stress generated by the bending, thereby limiting springback.

Because of the reduction of springback, this method only solves one of the problems mentioned above. Further, because of the local hardening which it generates, this method cannot be applied to steels having high mechanical resistance, already sufficiently difficult to apply. Finally, this method assumes the use of steels capable of undergoing a martensitic or bainitic phase transformation during annealing followed by quenching, which in fact limits its use to carbon-manganese steels.

### SUMMARY OF THE DISCLOSURE

The object of the present disclosure is to facilitate the shaping of stainless steel sheets having high mechanical resistance. It was designed and carried out in order to overcome the defects shown earlier and for obtaining other advantages.

For this purpose, the first object of the disclosure is a stainless steel sheet containing a minimum of 10.5% by weight of Cr and a maximum of 1.2% by weight of C, the microstructure of which is martensitic or austeno-martensitic and comprises at least 2% by volume of martensite. This metal sheet is essentially characterized in that in comprises at least one local portion of lesser mechanical resistance, having a martensite content at least 10% less than of that of the remainder of said metal sheet; said local portion being at least partly with a thickness equal to that of said sheet.

The steel sheet according to the disclosure with a thickness e, may also comprise the optional following features, taken individually or as a combination:
The local portion with lesser mechanical resistance has a width comprised between e and 25e at the surface of said metal sheet.
The mechanical resistance upon breaking the steel sheet is greater than or equal to 850 MPa outside said local portion.
The local portion of lesser mechanical resistance is obtained:
   either by a local heat treatment of a martensitic or austeno-martensitic stainless steel sheet with homogeneous mechanical resistance.
   or by differential work-hardening of an austenitic or austeno-martensitic stainless steel sheet with homogeneous mechanical resistance.
The local portion of lesser mechanical resistance has a martensite content at least twice less than that of the remainder of the sheet and preferentially at least four times less than that of the remainder of the sheet.

Therefore, it will be understood that the solution to the posed technical problem consists of locally treating areas of the sheet so as to lower the mechanical resistance and thereby facilitate deformation thereof.

A second object of the disclosure is formed by a method for manufacturing a steel sheet according to the disclosure, essentially comprising the steps according to which:
An austenitic, martensitic or austeno-martensitic steel sheet is supplied, said steel being a stainless steel containing a minimum of 10.5% by weight of Cr and a maximum of 1.2% by weight of C.
All or part of said sheet is optionally work-hardened.
At least one local portion of said sheet is treated so as to obtain a local portion of lesser mechanical resistance, having a martensite content at least 10% less than that of the remainder of said sheet; said local portion being at least partly with a thickness equal to that of said steel sheet.

The method according to the disclosure may also comprise the optional following feature:
The local portion of lesser mechanical resistance is obtained:
   either by local heat treatment of a martensitic or austeno-martensitic steel sheet with homogeneous mechanical resistance, the heat treatment resulting from a thermal rise in temperature by a laser, by induction, by an electron beam or by seam welding.
   or by differential work hardening of an austenitic or austeno-martensitic steel sheet with homogeneous mechanical resistance.

A third object of the disclosure is formed by a steel part which may be obtained by deformation of a steel sheet according to the disclosure or of a sheet obtained with the method according to the disclosure, said deformation occurring in at least one of said local portions with lesser mechanical resistance.

The part according to the disclosure may also comprise the following optional features:
It may be obtained by bending, profiling or die-stamping from at least one of said local portions of lesser mechanical resistance.
It may be obtained by cutting a steel sheet according to the disclosure or a sheet obtained with the method according to the disclosure.
It may be used for manufacturing metal structures withstanding dynamic stresses.

Other features and advantages of the disclosure will become apparent upon reading the description which follows.

The terms 2H, C700 to C1300 (so-called work-hardened state), 1E, 1D, 2B, 2D, 2R, 2E (so-called annealed state), notably relate to the standards which define the manufacturing ranges and the technical conditions for delivering the relevant steels (NF EN 10088-1 and -2 for stainless steels). C1500 will designate a manufacturing range with work-hardening 2H guaranteeing a mechanical resistance greater than 1,500 MPa.

The stainless steel sheets considered by the present disclosure are characterized by their mechanical resistance. The latter is controlled by the additive elements on the one hand, but also by the heat treatments and the mechanical treatments to which the sheet may be subject.

The additive elements define the base grade of the relevant sheet and therefore its intrinsic mechanical resistance. Within the scope of the present disclosure, by a stainless steel with an austenitic structure is meant a sheet comprising in weight percent:
10.5≦Cr≦20
0.005≦C≦1.2
0.005≦N≦2.
0.6≦Ni≦15
0.1≦Mn≦15
0.1≦Mo≦5
0.1≦Cu≦3
0.05≦Si≦3
0.0001≦Ti≦1

0.0001≦Nb≦1

The remainder of the composition consisting of iron and of inevitable impurities due to the elaboration.

It being further understood that the contents observe the following relationships:
1.48<Cr_{eq}/Ni_{eq}<2.2 with:

Cr_{eq}=% Cr+1.37% Mo+1.5% Si+2% Nb+3% Ti

Ni_{eq}=% Ni+0.31% Mn+22% C+14.2% N+% Cu
α′(30/20)>0, α′ being defined by the following relationship:

α′(30/20)=374.05−3.73% Cr−23.03% Ni−503.11% C−161.70% N−21.55% Mn

This composition characterizes an austenitic stainless steel which solidifies into a primary ferrite and which contains a non-zero amount of work-hardening martensite after deformation. Although consisting in majority of austenite, conventional austenitic grades contain trace amounts of residual ferrites from the solidification as well as trace amounts of martensite resulting from lamination operations.

The heat treatment and the mechanical treatment, either alone or combined, as for them, allow modification of this mechanical resistance in a certain proportion.

The present disclosure notably considers two possible alternatives:
homogeneous mechanical treatment on the entirety of the sheet followed by local heat treatment
inhomogeneous mechanical treatment over the entirety of the sheet

In both cases, modification of the mechanical characteristics is made possible by the capability of the relevant sheet of undergoing phase transformations on the one hand and variations in the density of dislocations on the other hand.

In the case of the first considered alternative, homogeneous work/hardening (manufacturing range 2H: C700 to C1500) over the entirety of the sheet causes partial transformation of austenite into martensite and optionally hardening of the austenite by densification of the dislocation network. This work-hardening gives the possibility of attaining mechanical resistances much greater than 780 MPa, a maximum value which may be reached on an annealed stainless steel of the type 1D, 1E, 2B, 2D, 2E, 2R. The thereby work-hardened steel is with an austeno-martensitic structure i.e. consisting at ordinary temperature of a mixture of austenite and martensite, the volume fraction of martensite being at least 2%. In a second step, heat treatment localized in the areas to be deformed causes partial reversion of the martensite into austenite and possibly softening of the austenite by the decrease in the number of dislocations. With this heat treatment, it is possible to locally lower the mechanical resistance of the sheet. A portion with a lesser mechanical resistance is thereby obtained. This mechanical resistance may be lowered down to 500 MPa, a minimum value which may be reached on an annealed austenitic stainless steel. This heat treatment may be carried out, without this list being exhaustive, by laser, by induction, by an electron beam or by seam welding. Regardless of the technique used, the thermal cycle notably comprises a rise in temperature above the temperature of the onset of transformation of the martensite into austenite, called the reversion temperature of martensite. This temperature depends on the relevant steel grade but within the scope of the disclosure and in order to cover the whole of the austenitic grades, the reversion temperature is assumed to be greater than 550° C. The durations of the heat treatment, of the heating, of the maintaining and cooling depend on the grade of the sheet, on its thickness and on the method used: they have to be determined beforehand and should allow a minimum 10% decrease of the martensite volume fraction and possibly of the dislocation density. This minimum decrease gives the possibility of getting rid of the local variations inherent to the work-hardening method. Partial melting of the steel at the surface of the sheet and over a thickness not exceeding 0.5e is acceptable. The heat-treated area is quenched by self-cooling, the heat being transmitted to the neighboring areas. This phenomenon suppresses the control of the quenching parameters for obtaining a sheet according to the disclosure.

In the case of the second considered alternative (inhomogeneous mechanical treatment), work-hardening is carried out by means of structured lamination cylinders. Work-hardening of stainless steels is usually carried out with smooth rolls. In the present case, these cylinders are engraved or splined so that portions of the work-hardened sheet are spared by this work-hardening and thus preserve their less work-hardened austenitic structure. This specific work-hardening is designated as differential work-hardening. Portions of lesser mechanical resistance are thereby obtained.

Regardless of the alternative views, the operating conditions are controlled so as to observe the following conditions:
the portion of lesser mechanical resistance is at least partly with a thickness equal to the thickness e of the sheet,
the portion of lesser mechanical resistance includes the area which might be deformed during a subsequent shaping step. For this purpose, it will be sought to include shaped areas for which the bending radii are comprised between 2 and 6 times the thickness of the sheet (case of the shaping of stainless steels having the highest mechanical resistances, without resorting to the present disclosure). For this reason, the portion of lesser mechanical resistance is preferably with a thickness comprised between e and 25e,
This portion may have various shapes, be linear, curvilinear, have a closed contour or further may have intersections with other portions of lesser mechanical resistance.
This portion has a martensite content at least 10% lower than that of the remainder of the sheet.

The presence on the stainless steel sheet of portions of lesser mechanical resistance, obtained by either one of the alternatives described above, allows:

severe bending of this sheet up to angles of 180° and down to minimum bending radii with a value of 0.5 time the thickness of the sheet
facilitated shaping since it is predetermined, avoiding slipping of the sheet or poor localization of the deformed area.
strong decrease in springback during the profiling, this springback being equivalent to what one would have with an annealed stainless steel of the type 2B, 2D, 2R, 2E, 1E, 1D
reduction in the bending force, this force being equivalent to what one would have with an annealed stainless steel of 2B, 2D, 2R, 2E, 1E, 1D, i.e. a 25 to 50% reduction depending on the relevant stainless steel grade.

In the case of a stainless steel sheet according to the disclosure, having undergone local treatment, the advantage provided by the slight coloration of the sheet generated by this heat treatment will also be noted: it allows localization of the area to be deformed without any difficulty. In the case of a stainless steel sheet according to the disclosure having undergone differential work-hardening, the localization of the area to be deformed is made possible by a less shiny aspect and a different roughness of the local portion.

A stainless steel sheet according to the disclosure may be shaped according to the usual techniques well known to one skilled in the art, from which bending, profiling, die stamping may be mentioned as examples. During this shaping, the portion of lesser mechanical resistance which encompasses the deformed area, undergoes work-hardening. By partial transformation of the austenite into martensite and possibly hardening of the austenite by densification of the network of dislocations, it is possible to at least partly find again the initial microstructure of this portion of the sheet. In the cases of deformation modes for which there exists a neutral fiber, a steel part, shaped at least at one of the portions of lesser mechanical resistance of a steel sheet according to the disclosure, is characterized by the presence, in the vicinity of the neutral fiber of an area having a lower martensite content than that of the sheet. The detection of this area may be accomplished by measuring residual stresses or by measuring the martensite fraction. By neutral fiber is meant the whole of the points which, in the case of application of an overall deformation, do not undergo local deformation.

A steel part, shaped at least at one of the portions of lesser mechanical resistance of a steel sheet according to the disclosure allows:
Improvement in the static or dynamic mechanical toughness, in larger residual elongation in the shaped areas avoiding brittle failures in a dynamic behavior (crash),
welding between two edges of the sheet facilitated by minimization of springback.

Moreover, the local portions of lesser mechanical resistance may not be shaped and may be used as preferential deformation areas during a dynamic stress, typically at a deformation rate comprised between 1 and 1,000s⁻¹ like in a crash.

### BRIEF DESCRIPTION OF THE DRAWINGS

In order to illustrate the disclosure, tests were carried out and will be described as non limiting examples, notably with reference to FIGS. 1 to 7 which illustrate:

FIG. 1A: An exemplary microstructure of a sheet according to the disclosure before localized heat treatment. A metallographic section with electrolytic etching.

FIG. 1B: Magnification of FIG. 1A with the martensite being dark and the austenite being bright.

FIG. 1C: Exemplary microstructure of a sheet according to the disclosure after localized heat treatment. Metallographic section with electrolytic etching.

FIG. 1D: Magnification of FIG. 1C. Detail of the untreated area.

FIG. 1E: Magnification of FIG. 1C. Detail of the local portion of lesser mechanical resistance.

FIG. 2: Average variation in the thickness of the sheet of the martensite content in the vicinity of the portion of lesser mechanical resistance (A) and structure of this portion (B).

FIG. 3A: A sheet according to the disclosure having areas of lesser mechanical resistance.

FIG. 3B: A part after bending the sheet shown in FIG. 3A.

FIG. 4A: A sheet according to the disclosure having areas of lesser mechanical resistance.

FIG. 4B: A part after bending the sheet shown in FIG. 4A.

FIG. 5A: A sheet according to the disclosure having areas of lesser mechanical resistance.

FIG. 5B: A part after die stamping of the sheet shown in FIG. 5A.

FIG. 6: Exemplary profiling of a sheet according to the disclosure by means of a profiling line and the part obtained.

FIG. 7A: A first embodiment of a sheet according to the disclosure.

FIG. 7B: Another embodiment of a sheet according to the disclosure.

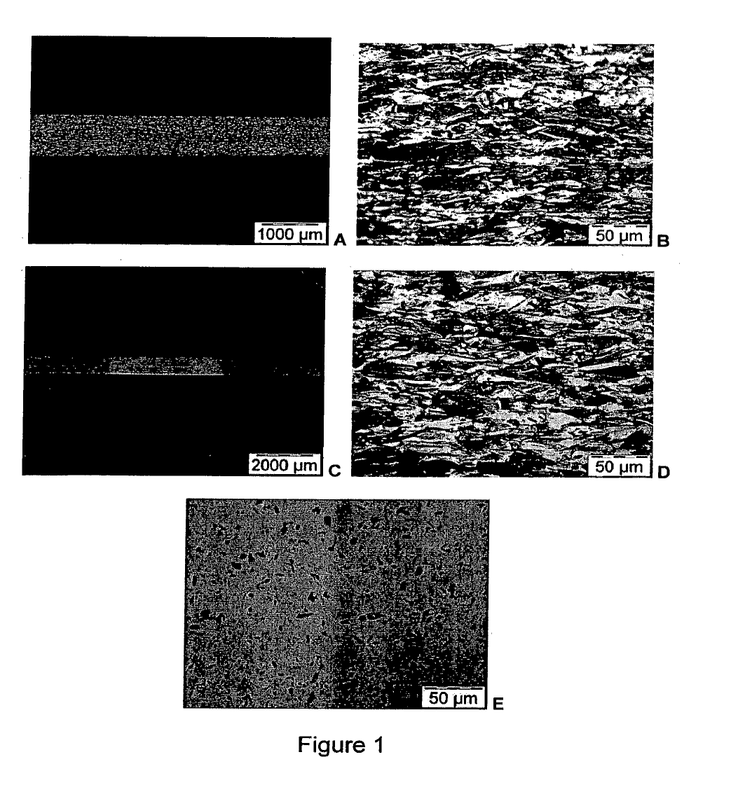

The measurement of the martensite content is carried out by local measurement of magnetic induction by means of a ferritescope. This measurement gives an average volume percentage of martensite on the thickness of the sheet. This indirect measurement assumes the use of a corrective factor depending on the relevant steel grade. In the case of a stainless steel 1.4318 (301 LN) or 1.4310(301), the corrective factor is 1.7. Direct measurement by signametry (saturation magnetic induction) may also be contemplated, although more restrictive to apply.

### EXAMPLES

With reference to FIG. 3A, a stainless steel sheet 1 according to the disclosure is locally treated so as to obtain four linear portions 3 of lesser mechanical resistance. With reference to FIG. 3B, the sheet 1 described earlier is bent at the portion 3 of lesser mechanical resistance so as to obtain the profile steel part 2.

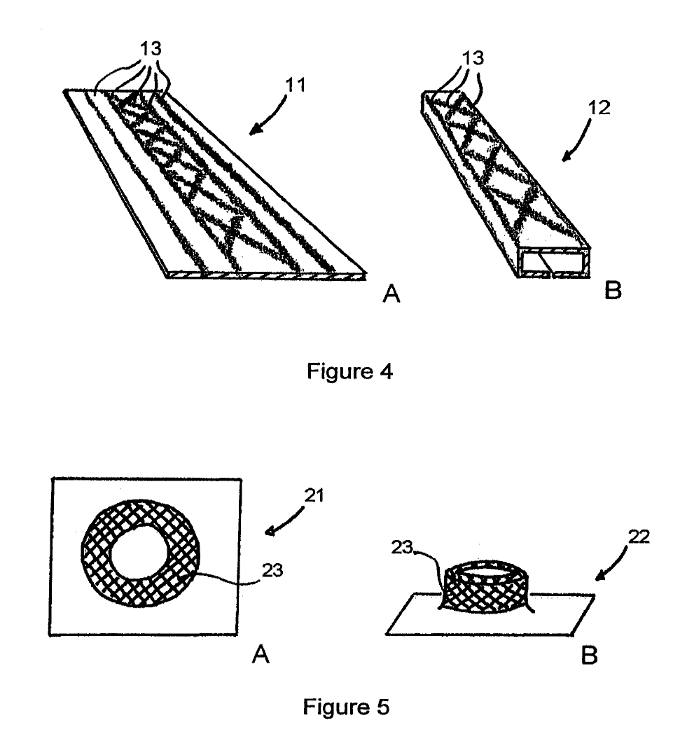

With reference to FIG. 4A, a stainless steel sheet 11 according to the disclosure is locally treated so as to obtain linear portions 13 of lesser mechanical resistance. With reference to FIG. 4B, the sheet 11 described earlier is bent at four portions 13 of lesser mechanical resistance so as to obtain the profile steel part 12. The non-shaped portions 13 of lesser mechanical resistance have an arrangement guiding the deformation of the profile steel part 12 during a dynamic stress of the crash type.

With reference to FIG. 5A, a stainless steel sheet 21 according to the disclosure, is locally treated so as to obtain a portion 23 of lesser mechanical resistance. With reference to FIG. 5B, the sheet 21 described earlier is die-stamped at the portion 23 of lesser mechanical resistance so as to obtain the steel part 22.

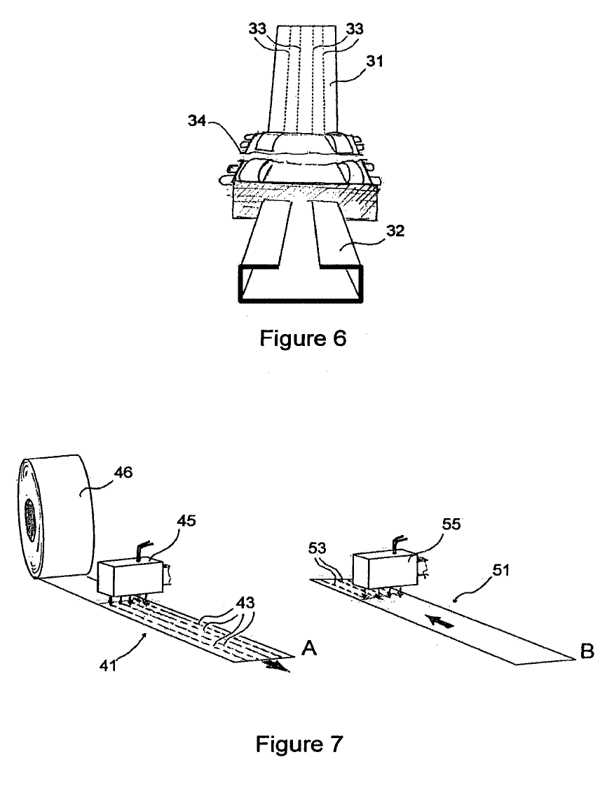

With reference to FIG. 6, a stainless steel sheet 31 according to the disclosure locally treated so as to obtain portions 33 of lesser mechanical resistance is profiled by means of a profiling line 34 in order to obtain a profiled steel part 32.

With reference to FIG. 7A, a steel coil 46 is unwound and undergoes local heat treatment by means of a laser 45 in order to obtain a stainless steel sheet 41 according to the disclosure, having four linear portions 43 of lesser mechanical resistance.

With reference to FIG. 7B, a stainless steel sheet 51, according to the disclosure undergoes local heat treatment by means of a laser 55, so as to obtain four linear portions 53 of lesser mechanical resistance.

According to a preferred embodiment, a work-hardened stainless steel 1.4318 (301 LN) is used such that its mechanical resistance Rm (conventional maximum tensile stress) is at least 1,000 MPa (C1000 state of the manufacturing range 2H according to the EN 10088/2). In this example, the thickness of the sheet is 0.8 mm and the metal contains about 45% by volume of martensite and 55% by volume of austenite.

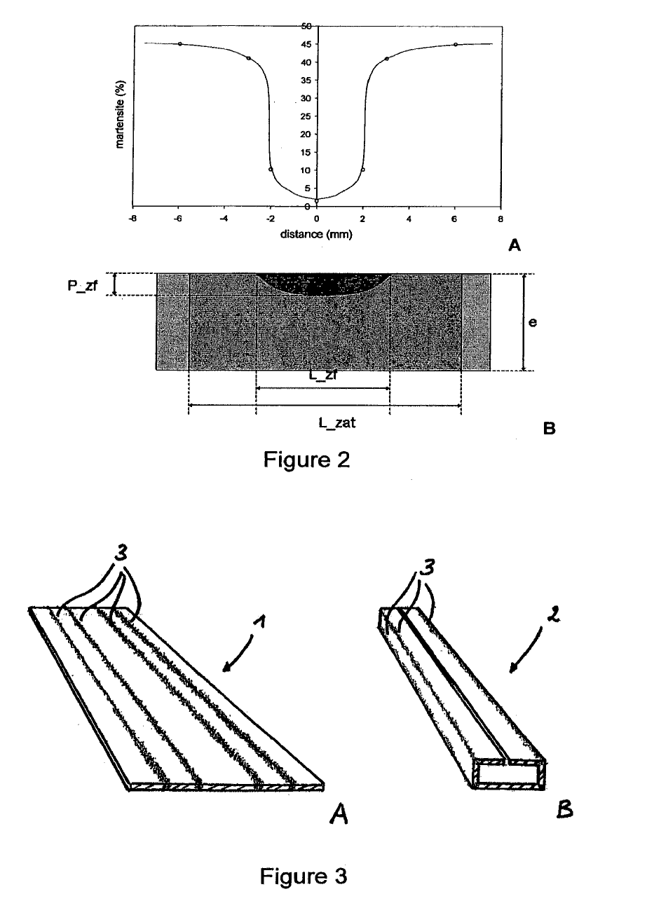

A localized heat treatment, along one line, is carried out by means of a laser of the CO₂ type of 4 kW. The power in the present case is 20%, the displacement of the source is 0.85 m/min (1 m/min also tested) and the focal point is located at 25 mm above the upper surface of the sheet. With reference to FIG. 2, the laser treatment gives the possibility of obtaining along the treatment line an annealed structure wherein the martensite percentage passes to a content of less than 10% and even 1.5% in the centre, close to the annealed state of this metal, i.e. before work-hardening (state 2B). The structure of the treated line comprises an austenitic molten area limited in width L_zf to 2-4 times the thickness of the sheet and with a depth P_zf of less than 50% of the thickness of the sheet as well as a thermally affected area with a width L_zat comprised between 3 and 6 times the thickness of the sheet. This area underwent almost total reversion of the martensite. The whole of the two identified areas forms the portion with lesser mechanical resistance.

Bending tests are carried out on the thereby treated C1000 sheets according to the disclosure and on untreated sheets. It is observed that the bending of the sheet C1000 treated according to the disclosure is possible up to angles of 180° without any difficulty, like for the annealed sheet 2B. On the other hand, bending is difficult at 90° with the untreated C1000 sheet, with the presence of small cracks, and impossible at 180° with sometimes complete failure of the test specimen (Tab.1).

TABLE 1
Bending tests on a grade 1.4318 state 2B, work-hardened
C1000 and work-hardened C1000 with a laser heat treatment

Bending
angle

| Sample | Rm (MPa) | 90° | 180° |
|---|---|---|---|
| 2B | 780 | ◯ | ◯ |
| C1000 | 1,000 | ♦ | |
| C1000 according to the | | ◯ | ◯ |
| Disclosure. | | | |

◯ proper pending,
♦ presence of cracks,
 failure of the sample

1. A stainless steel sheet containing a minimum of 10.5% by weight of Cr and a maximum of 1.2% by weight of C, the microstructure of which is martensitic or austeno-martensitic and comprises at least 2% by volume of martensite, comprising at least one local portion of lesser mechanical resistance, having a martensite content at least 10% lower than that of the remainder of the sheet, the local portion being at least partly with a thickness equal to that of the sheet.

2. The steel sheet according to claim 1, with a thickness e, the local portion of which has a width comprised between e and 25e at the surface of the sheet.

3. The steel sheet according to claim 1, the mechanical resistance at break of which is greater than or equal to 850 MPa outside the local portion.

4. The steel sheet according to claim 1, the local portion of which with lesser mechanical resistance is obtained:
either by local heat treatment of a martensitic or austeno-martensitic stainless steel sheet of homogeneous mechanical resistance
or by differential work-hardening of an austenitic or austeno-martensitic stainless steel sheet of homogeneous mechanical resistance.

5. The steel sheet, according to claim 1, the local portion of which with lesser mechanical resistance has a martensite content at least twice smaller than that of the remainder of the sheet.

6. The steel sheet according to claim 4, the local portion of which with lesser mechanical resistance has a martensite level at least four times smaller than that of the remainder of the sheet.

7. A method for manufacturing a steel sheet, according to claim 1, comprising the steps according to which:
an austenitic, martensitic or austeno-martensitic steel sheet is supplied, the steel being a stainless steel containing a minimum of 10.5% by weight of Cr and a maximum of 1.2% by weight of C;
optionally, all or part of the sheet is work-hardened so that the microstructure comprises at least 2% by volume of martensite;
the sheet is treated so as to obtain at least one local portion of lesser mechanical resistance, having a martensite content at least 10% lower than that of the remainder of the sheet; the local portion being at least partly with a thickness equal to that of the steel sheet.

8. The method according to claim 7, wherein the local portion of lesser mechanical resistance is obtained:
either by local heat treatment of a martensitic or austeno-martensitic steel sheet of homogeneous mechanical resistance, the heat treatment resulting from a thermal rise in temperature by laser, by induction, by an electron beam or by seam welding;
or by differential work-hardening of an austenitic or austeno-martensitic steel sheet of homogeneous mechanical resistance.

9. A steel part which may be obtained by deformation of a steel sheet according to claim 1 or of a sheet obtained by the method, wherein:
an austenitic, martensitic or austeno-martensitic steel sheet is supplied, the steel being a stainless steel containing a minimum of 10.5% by weight of Cr and a maximum of 1.2% by weight of C;
optionally, all or part of the sheet is work-hardened so that the microstructure comprises at least 2% by volume of martensite; and
the sheet is treated so as to obtain at least one local portion of lesser mechanical resistance, having a martensite content at least 10% lower than that of the remainder of the sheet; the local portion being at least partly with a thickness equal to that of the steel sheet;
the deformation occurring in at least one of the local portions of lesser mechanical resistance.

10. The steel part according to claim 9, obtained by bending, profiling or stamping of at least one of the local portions of lesser mechanical resistance.

11. A steel part which may be obtained by cutting a steel sheet according to claim 1 or a sheet obtained by the method wherein:
an austenitic, martensitic or austeno-martensitic steel sheet is supplied, the steel being a stainless steel containing a minimum of 10.5% by weight of Cr and a maximum of 1.2% by weight of C;
optionally, all or part of the sheet is work-hardened so that the microstructure comprises at least 2% by volume of martensite; and
the sheet is treated so as to obtain at least one local portion of lesser mechanical resistance, having a martensite content at least 10% lower than that of the remainder of the sheet; the local portion being at least partly with a thickness equal to that of the steel sheet;
the deformation occurring in at least one of the local portions of lesser mechanical resistance.

12. The use of a part according to claim 9 for manufacturing metal structures withstanding dynamic stresses.

13. A steel part which may be obtained by deformation of a steel sheet according to claim 1, wherein:
the local portion of lesser mechanical resistance is obtained either by local heat treatment of a martensitic or austeno-martensitic steel sheet of homogeneous mechanical resistance, the heat treatment resulting from a thermal rise in temperature by laser, by induction, by an electron beam or by seam welding; or
by differential work-hardening of an austenitic or austeno-martensitic steel sheet of homogeneous mechanical resistance;
the deformation occurring in at least one of the local portions of lesser mechanical resistance.

14. A steel part which may be obtained by cutting a steel sheet according to claim 1, wherein:
the local portion of lesser mechanical resistance is obtained either by local heat treatment of a martensitic or austeno-martensitic steel sheet of homogeneous mechanical resistance, the heat treatment resulting from a thermal rise in temperature by laser, by induction, by an electron beam or by seam welding; or
by differential work-hardening of an austenitic or austeno-martensitic steel sheet of homogeneous mechanical resistance;
the deformation occurring in at least one of the local portions of lesser mechanical resistance.

15. The use of a part according to claim 10 for manufacturing metal structures withstanding dynamic stresses.

16. The use of a part according to claim 11 for manufacturing metal structures withstanding dynamic stresses.
